(19) United States
(12) Patent Application Publication
(10) Pub. No.: US 2012/0261931 A1
(43) Pub. Date: Oct. 18, 2012

(54) Length Adjustable Remote Manipulation Device

(76) Inventor: Hee Seok KANG, Seoul (KR)

(21) Appl. No.: 13/405,540

(22) Filed: Feb. 27, 2012

(30) Foreign Application Priority Data
Apr. 13, 2011 (KR) 10-2011-0034295

(51) Int. Cl. B66C 1/42

(52) U.S. Cl. 294/86.4

(57) ABSTRACT

A length adjustable remote manipulation device includes a body member including a first body with an empty space formed inside and a second body installed movably along the first body while inserted inside the first body such that the length thereof is adjustable, an manipulation member installed at an end of the first body and including a handle with a movable member supported elastically by spring, a motion-copying member installed at an end of the second body and including pincers, and a first cable for having the pincers operated according to movement of the movable member by connecting the movable member and the pincers.

### FIELD OF THE INVENTION

The present invention relates to a length adjustable remote manipulation device, more specifically to a length adjustable remote manipulation device for picking fruits such as persimmons high in the air, holding and manipulating an object in a distance, or catching an object which is hard to grab with a hand.

### BACKGROUND

Pincers are disclosed in Korean Utility Model Registration No. 20-0428883 (Title: Multi-purpose Pincers, Inventor: Mandeok Seo, referred to as ‘prior art document’ below), which are for holding an object which is hard to grab with a hand and provide a large holding power by rotating tongs by engaging structure of gears according to manipulation of lever formed in the handle. The multi-purpose pincers disclosed therein include first and second gear members formed inside first and second tongs, rack gear engaged thereto, a cable connecting the rack gear to lever, and a return spring for recovering the rack gear, and is configured to rotate the first and second tongs and catch or release an object.

The multi-purpose pincers disclosed in the prior art document performs a single function of manipulating the lever, rotating the first and second tongs, and catching or releasing the object, such that they cannot manipulate the grabbed object variously and they cannot change length thereof on demand.

### SUMMARY OF THE INVENTION

An object of the present invention is to provide a length adjustable remote manipulation device, which can adjust the length of body member and maintains an initial tension of power delivering member for delivering power of cable and manipulator used for operating the pincers even with the length of body member adjusted.

Another object of the present invention is to provide a length adjustable remote manipulation device, which can adjust the length of body member and also can rotate the pincers while holding the object with the pincers.

Still another object of the present invention is to provide a length adjustable remote manipulation device, which can adjust the length of body member and also can bend the pincers sideways while holding the object with the pincers.

Still another object of the present invention is to provide a length adjustable remote manipulation device, which can adjust the length of body member and also can perform three operations of holding the object with pincers, rotating the pincers while holding the object with the pincers, and bending the pincers sideways while holding the object with the pincers.

Still another object of the present invention is to provide a length adjustable remote manipulation device, which can adjust the length of body member and also can copy a rotational operation of a handle about a first rotational axis and a second rotational operation of the handle about a second rotational axis to a motion-copying member where the pincers are installed.

Still another object of the present invention is to provide a length adjustable remote manipulation device, which can maintain a state of the length of the body member adjusted stably.

Still another object of the present invention is to provide a length adjustable remote manipulation device, which can adjust the length of body member, and in which the operator can feel the force applied to the pincers as it is.

Still another object of the present invention is to provide a length adjustable remote manipulation device, which can adjust the length of body member, and the operation member and the motion-copying member can rotate while being bent with respect to the body member.

The length adjustable remote manipulation device according to the invention comprises a body member including a first body with an empty space formed inside and a second body installed movably along the first body while inserted inside the first body such that the length thereof is adjustable; an manipulation member installed at an end of the first body and including a handle with a movable member supported elastically by spring; a motion-copying member installed at an end of the second body and including pincers; and a first cable for having the pincers operated according to movement of the movable member by connecting the movable member and the pincers, wherein at the first body is installed a first movable pulley device hooked in the first cable movably in a length direction of the first body, in the first body between the first movable pulley device and the handle and in the second body between the first movable pulley device and the pincers are installed guiding rollers for adjusting the path of the first cable, and wherein the first movable pulley device is hooked to the second cable having an end fixed to the first body and the other end fixed to the second body, so as to prevent the first cable from being loosened or tightened than before expansion or contraction according to the expansion or contraction of the body member.

The device may further comprise a first bevel gear installed rotatably at the first body about a first rotational axis in a length directional of the first body and supporting the handle; a second bevel gear disposed at the second body facing the first bevel gear, installed rotatably about a second rotational axis in the length direction of the second body, and supporting the pincers; a third bevel gear installed at the first body rotatably in place about a third rotational axis an extending line of which crosses with an extending line of the first rotational axis; a fourth bevel gear installed at the second body rotatably in place about a fourth rotational axis an extending line of which crosses with an extending line of the second rotational axis; and a power-delivering member for delivering a rotational power of the third bevel gear to the fourth bevel gear.

Inside the first body is movably installed a second movable pulley device hooked to the power-delivering member movably in a length direction of the first body, in the first body between the second movable pulley device and the third rotational axis and in the second body between the second movable pulley device and the fourth rotational axis are installed guiding rollers for adjusting path of the power-delivering member, and the second movable pulley device is hooked to a third cable having an end fixed to the first body and the other end fixed to the second body, so as to prevent the power-delivering member from being loosened or tightened than before expansion or contraction according to the expansion or contraction of the body member.

In one of the first body and the second body is installed a rack gear, and in the other one may be installed a worm gear engaging the rack gear and a motor for rotating the worm gear.

A pair of third bevel gears engage both sides of the first bevel gear respectively so as to rotate oppositely to each other about the third rotational axis if the first bevel gear rotates about the first rotational axis, and a pair of fourth bevel gears engage both sides of the second bevel gear respectively so as to rotate oppositely to each other about the second rotational axis if the second bevel gear rotates about the second rotational axis.

As rotating the handle about the first rotational axis, the motion-copying member where the pincers are installed is configured to rotate in a direction same as or opposite to the direction of the handle about the second rotational direction.

As rotating the handle about the third rotational axis, the motion-copying member where the pincers are installed is configured to rotate in a direction same as or opposite to the direction of the body member about the fourth rotational direction.

### BRIEF DESCRIPTION OF THE DRAWINGS

FIG. 1 is a cross-section view showing a remote manipulation device of a type of fixed length;

FIG. 2 is a diagram explaining a state connecting handle and first cable;

FIG. 3 is a diagram explaining a state connecting the first cable and pincers;

FIG. 4 is a cross-sectional view showing a variation of embodiment in FIG. 1;

FIG. 5 is a plan view showing an embodiment of a length adjustable remote manipulation device according to the invention; and

FIG. 6 is a side view showing a state connecting a power-delivering member in the length adjustable remote manipulation device in FIG. 5.

### DETAILED DESCRIPTION OF THE PREFERRED EMBODIMENTS OF INVENTION

Below, preferred embodiments of the present invention are described in detail referring to the attached drawings.

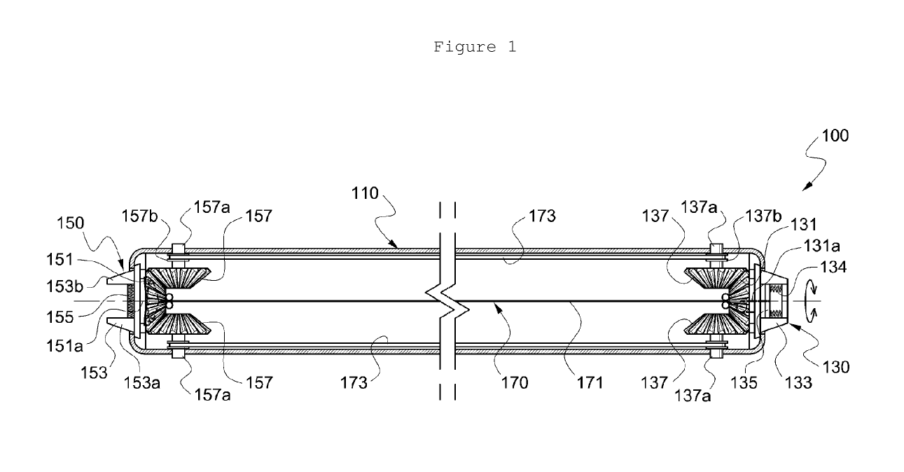

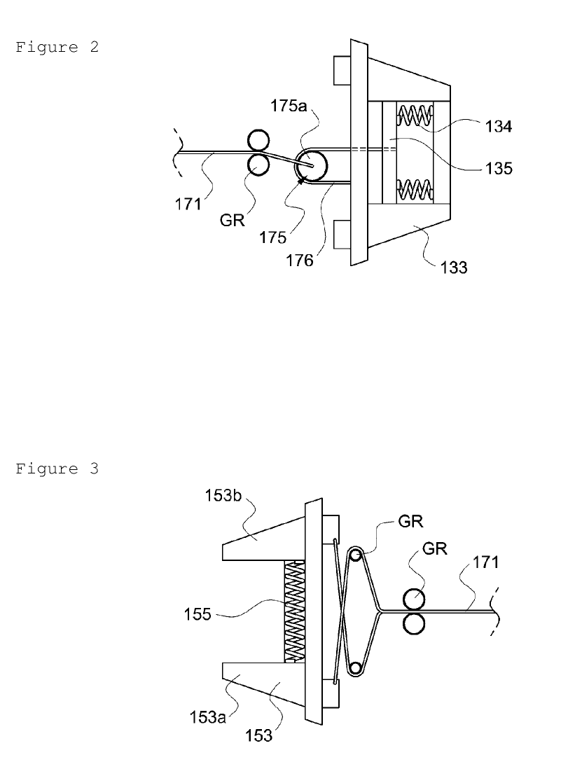

FIG. 1 is a cross-section view showing a remote manipulation device of a type of fixed length, FIG. 2 is a diagram explaining a state connecting handle and first cable, and FIG. 3 is a diagram explaining a state connecting the first cable and pincers.

As shown in FIGS. 1-3, the remote manipulation device 100 according to the invention comprises a body member 110, a manipulation member 130 installed at an end of the body member 110, a motion-copying member 150 installed at the other end of the body member 110 and operated by manipulation of the manipulation member 130, and a power-delivering member 170 for delivering force of the manipulation member 130 such as a first cable 171 and a power-delivering member 173 to the motion-copying member 150.

The body member 110 provides locations for installing the manipulation member 130, motion-copying member 150, first cable 171, power-delivering member 173, etc., is preferably of a shape of tube. In cases, a length adjustable one can be used for the body member 110, embodiments of which is going to be described in detail later.

The remote manipulation device 100 according to the invention includes the manipulation member 130. The manipulation member 130 is installed at an end of the body member 110, and includes a first bevel gear 131 installed rotatably about a first rotational axis 131a in a length direction of the body member 110. To the first bevel gear 131 is fixed a handle 133. If rotating clockwise or counterclockwise the handle 133 about the first rotational axis 131a, the first bevel gear 131 also rotates clockwise or counterclockwise. In the handle 133 is installed a movable member 135 supported elastically by the spring 134. To the movable member 135 is connected a first cable 171 for operating the pincers 153 of the motion-copying member 150. Preferably, the first cable 171 is connected to the movable member 135 of the handle 133 through a guiding roller GR and a movable pulley device 175. The movable pulley device 175 comprises a movable pulley device 175a and a pincers-operating cable 176 having an end connected to the movable member 135 and the other end fixed to other side of the handle 133 while being hooked to the movable pulley device 175a.

In the other end of the body member 110 is installed a motion-copying member 150. The motion-copying member 150 is a part operated by manipulation of the manipulation member 130 and includes a second bevel gear 151 installed rotatably about the second rotational axis 151a. In FIG. 1, the second rotational axis 151a lies on a line same as the first rotational axis 131a, but may lie not on the same when the manipulation member 130 and the motion-copying member 150 rotates in a direction bent with respect to the body member 110 or when a curved or bent body member 110 is used. The second bevel gear 151 is disposed facing the first bevel gear 131. In the second bevel gear 151 is installed the pincers 153. In this embodiment, the pincers 153 include two movable pincer tongs 153a, 153b disposed with an interval and a spring 155 supporting elastically between the pincer tongs 153a, 153b. The two pincer tongs 153a, 153b are connected to the first cable 171. The first cable 171 has an end portion divided into two branches and passing the guiding rollers GR on both sides, crossed again, and then connected to the two pincer tongs 153a, 153b respectively.

Thus if pulling the movable member 135 to the right, the first cable 171 is pulled to the right, and the pincer tongs 153a, 153b are closed more so as to be able to grab an object. If released, the movable member 135 moves to the left by the spring 134 supporting the movable member 135 and returns to an initial position, and the two pincer tongs 153a, 153b also move in an opening direction by the spring 155 supporting between them and return to an initial position. Thus the first cable 171 also returns to an initial position. The operation of the pincer tongs 153a, 153b may use prior arts different from FIG. 3, and since they are not related to an essence of the invention and use the prior arts as they are it is not going to be discussed here in detail.

That is, the first cable 171 connects the movable member 135 and the pincers 153, performing a function for operating the pincers 153 according to a movement of the movable member 135.

The remote manipulation device 100 according to the invention includes a third bevel gear 137 engaging the first bevel gear 131. The third bevel gear 137 is installed in the body member 110 neighboring the first bevel gear 131 rotatably in place about a third rotational axis 137a. The extended line of the third rotational axis 137a crosses with an extended line of the first rotational axis 131a, and preferably meets the first rotational axis 131a with about 90 degrees. Such third rotational axis 137amay be installed on one side of the first bevel gear 131, but preferably a pair of third bevel gears 137 are installed so as to engage at both sides of the first bevel gear 131 respectively. In the third rotational axis 137a is installed a pulley 137b for hooking the power-delivering member 173.

The first bevel gear 131 described in the above, in a state of engaging the third bevel gear 137, preferably may rotate about the third rotational axis 137a, the rotational axis of the third bevel gear 137 and bend sideways with respect to the body member 110. In order that the first bevel gear 131 rotates about the third rotational axis 137a freely, the contacting portions of the handle 133 and the body member 110 are formed as curved surfaces. Also, in an end of the body member 110 is a formed a through-hole in a direction along which the handle 133 bends to an angle allowing the handle 133 to rotate. This through-hole has a shape of oblong hole formed long along a direction where the handle 133 bends along the curved surfaces.

The remote manipulation device 100 according to the invention includes a fourth bevel gear 157 engaging the second bevel gear 151. The fourth bevel gear 157 is installed in the body member 110 neighboring the second bevel gear 151 rotatably in place about the fourth rotational axis 157a. The extended line of the fourth rotational axis 157a crosses with the extended line of second rotational axis 151a, and preferably forms 90 degrees with the second rotational axis 151a. The fourth bevel gear 157 may be installed on one side of the second bevel gear 151, but preferably a pair of them may be provided so as to engage both sides of the second bevel gear 151 respectively. In the fourth rotational axis 157a, a rotational axis of the fourth bevel gear 157, is installed a pulley 157b.

The second bevel gear 151 described in the above, in a state engaging the fourth bevel gear 157, preferably may rotate about the fourth rotational axis 157a, the rotational axis of the fourth bevel gear 157, and be bent with respect to the body member 110.

To a pulley 137b of the third bevel gear 137 and a pulley 157b of the fourth bevel gear 157 is hooked a power-delivering member 173. For the power-delivering member 173 may be used a belt or cable.

Referring to FIGS. 1-3, the operation of the remote manipulation device 100 according to the invention may be described as follows.

First, in order to grab an object with the pincers 153, a user pulls the movable member 135 to the right. Then the first cable 171 is pulled to the right, and the two pincer tongs 153a, 153b move toward so as to close and grab the object with the pincers 153. If releasing the movable member 135 which was held with a hand, the movable member 135 and the two pincer tongs 153a, 153b return to the original positions by the force of the springs 134, 155.

Also, if rotating the handle 133 clockwise or counterclockwise about the first rotational axis 131a in the state of FIG. 1, the two third bevel gears 137 disposed facing each other rotate in opposite directions to each other. Then, by the power-delivering member 173 hooked by the pulleys 137b, 157b of the third bevel gear 137 and the fourth bevel gear 157, the two fourth bevel gears 157 also rotate in opposite directions to each other. Then, the second bevel gear 151 engaging the two fourth bevel gears 157 rotates in a direction opposite to the first bevel gear 131. In order to rotate the second bevel gear 151 in the same direction as the first bevel gear 131, the power-delivering member 173 connecting the pulley 137b of the third bevel gear 137 and the pulley 157b of the fourth bevel gear 157 should be crossed and hooked. The rotation of the manipulation member 130 and the motion-copying member 150 about the first rotational axis 131a and the second rotational axis 151a is possible in states of holding the object with the pincers 153 or releasing, and as described later, it is also possible in states in which the handle 133 and the pincers 153 or the manipulation member 130 and the motion-copying member 150 are bent with respect to the body member 110.

Also, when the user holds the handle 133 and rotates the first bevel gear 131 around the third rotational axis 137a so as to bend it sideways with respect to the body member 110, the two third bevel gears 137 rotates about the third rotational axis 137a in a direction together with the handle 133 and the first bevel gear 131 in a state of engaging with the first bevel gear 131, and the handle 133 may be bent sideways with respect to the body member 110. Then, the two fourth bevel gears 157 connected to the third bevel gear 137 through the power-delivering member 173 also rotate about the fourth rotational axis 157a in the same direction. Then, the second bevel gear 151 engaging the fourth bevel gear 157 and the entire motion-copying member 150 including the second bevel gear 151 rotate about the fourth rotational axis 157a in a same direction as the first bevel gear 131 and is bent sideways with respect to the body member 110. Since both of the handle 133 and the motion-copying member 150 are located outside the third rotational axis 137a and the fourth rotational axis 157a, the motion-copying member 150 is bent in a direction opposite to the handle 133 or the manipulation member 130. In a case of bending the motion-copying member 150 in a same direction as the handle 133, as in the above, the power-delivering member 173 connecting the pulley 137b of the third bevel gear 137 and the pulley 157b of the fourth bevel gear 157 should be hooked in a shape of X.

The rotational motions of the manipulation member 130 and the motion-copying member 150 about the third rotational axis 137a and the fourth rotational axis 157a are all possible in a state of releasing the object as well as in a state of holding the object, and as described in the above, they are possible in a state in which the manipulation member 130 and the motion-copying member 150 are rotated about the first rotational axis 131a and the second rotational axis 151a.

That is, in a case of using the remote manipulation device 100 according to the invention, the pincers 153 can be rotated or bent sideways with respect to the body member 110 while holding an object, and the pincers 153 can be rotated about the second rotational axis 151a while bending the pincers 153 sideways with respect to the body member 110.

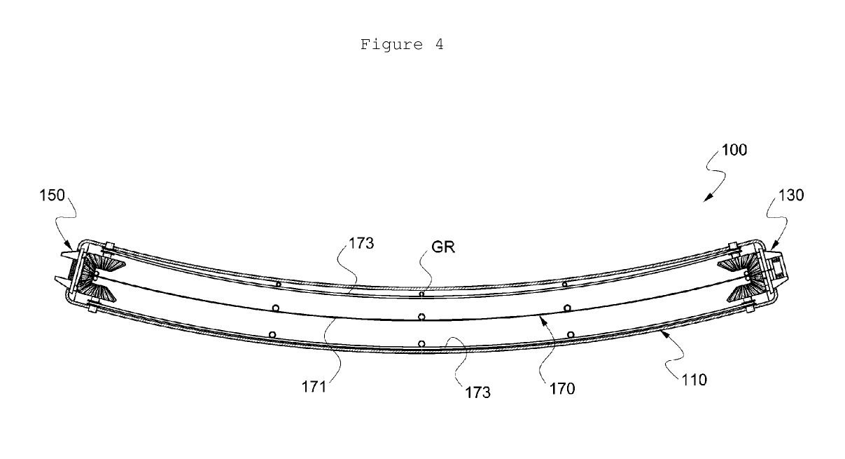

FIG. 4 is a cross-sectional view showing a variation of embodiment in FIG. 1.

In cases, for the body member 110 can be used a curved thing, rather than a straight one. In such a case, in order for the first cable 171 and the power-delivering member 173 move without interference from the body member 110, at a necessary location of the body member 110 can be installed guiding rollers GR. The rest is same as described regarding FIGS. 1-3.

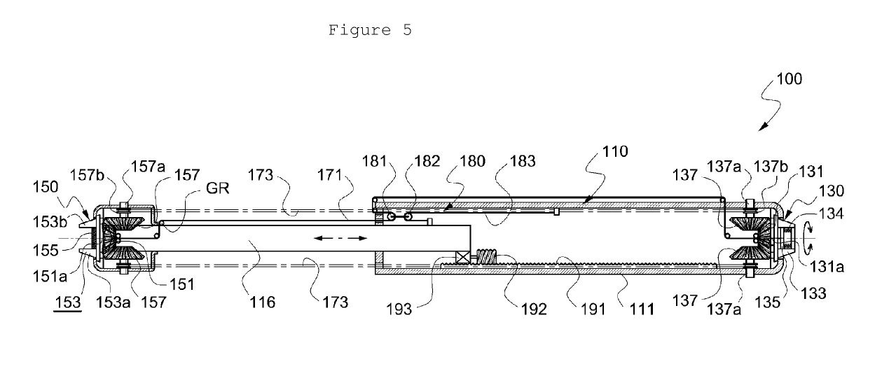

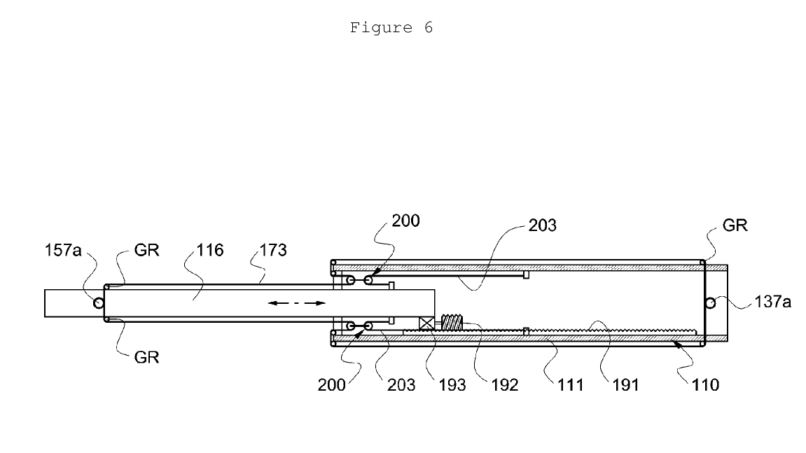

FIG. 5 is a plan view showing an embodiment of a length adjustable remote manipulation device according to the invention, and FIG. 6 is a side view showing a state connecting a power-delivering member in the length adjustable remote manipulation device in FIG. 5.

The body member 110 in the remote manipulation device 100 shown in FIGS. 5 and 6 includes a first body 111 and a second body 116 installed so as to move along the first body 111, the difference from the previous embodiment is that the length is adjustable.

The first body 111 is preferably made with a tube having an empty inside. In the inside of the first body 111 is installed a first movable pulley device 180 hooked to the first cable 171 movably in a length direction of the first body 111, and in the first body 111 between the first movable pulley device 180 and the handle 133 and in the second body 116 between the first movable pulley device 180 and the pincers 153 are installed the guiding rollers GR for adjusting the path of the first cable 171. This first movable pulley device 180 includes a first pulley 181 hooked to the first cable 171 and a second pulley 182 connected thereto. This first movable pulley device 180 is hooked to the second cable 183 which is in a state of having one end fixed to the first body 111 and the other end fixed to the second body 116, through the second pulley 182. Such first movable pulley device 180 and second cable 183 perform a function to prevent the first cable 171 from being loosened or tightened according to the expansion or contraction of the body member 110 than before such expansion or contraction. In cases, the first pulley 181 and the second pulley 182 may be installed on a same axis.

As illustrated, inside the first body 111 is installed a rack gear 191 along a length direction of the first body 111, and in the second body 116 are installed a worm gear 192 engaging the rack gear 191 and a motor 193 for rotating the worm gear 192. When the remote manipulation device 100 is large, the electrical power for operating the motor 193 may be supplied from outside. When the remote manipulation device 100 is small, a battery may be used to power the motor 193.

That is, in a state of FIG. 5, if rotating the worm gear 192 engaging the rack gear 191 by operating the motor 193, the second body 116 moves to the right. Then the length of the body member 110 is shortened. As the second body 116 moves to the right, the second cable 183 connected to the second body 116 pulls the first movable pulley device 180 to the right. Then, the first cable 171 is also pulled to the right by the first movable pulley device 180, maintaining the initial tension. If operating the motor 193 in a direction opposite to the previous case, the second body 116 moves to the left, and then the length of the body member 110 is lengthened. In such a case, the first movable pulley device 180 is pulled to the left by the first cable 171 and moves to the left, and as the second pulley 182 connected to the second body 116 moves to the left, allowing the first pulley 181 and the second pulley 182 to move to the left and maintaining the tension of the first cable 171 and the second cable 183 as they were.

As in the above, when the length of the body member 110 is expanded or shrunk, the power-delivering member 173 for delivering the rotational power of the third rotational axis 137a to the fourth rotational axis 157a should be able to maintain its initial tension, which is described referring to FIG. 6.

Referring to FIGS. 5 and 6, inside the first body 111 is installed a second movable pulley device 200 hooked to the power-delivering member 173 movably in a length direction of the first body 111. To the first body 111 between the second movable pulley device 200 and the third rotational axis 137a and the second body 116 between the second movable pulley device 200 and the fourth rotational axis 157a are installed guiding rollers GR for adjusting path of the power-delivering member 173.

Also, the second movable pulley device 200 is hooked to a third cable 203 having an end fixed to the first body 111 and the other end fixed to the second body 116.

The structure of the second movable pulley device 200 is same as the first movable pulley device 180 described earlier.

One more rack gear 191, motor 193, and worm gear 192, similar to what is shown in FIG. 5, may be installed along the inside of the first body 111, and the same ones as in FIG. 5 may be used as they are.

Then in FIG. 6, if rotating the worm gear 192 by operating the motor 193, the second body 116 moves along the inside the first body 111 following the rack gear 191, such that even though the length of the body member 110 is expanded or shrunk, the power-delivering member 173 is prevented from expanding or shrinking than before through the operations of the second movable pulley device 200 and the third cable 203.

The rest is same as what was described regarding FIG. 1 through FIG. 3.

### EFFECTS OF INVENTION

A remote manipulation device according to the invention does not have complex structure, but still adjusts a length of body member, and even though the length of the body member is changed the initial tension of cable to operate pincers and of power-delivering member for delivering power of manipulating member to operating member is maintained as it was.

A length adjustable remote manipulation device according to the invention can adjust the length of body member, grab an object using pincers, rotate the pincers, and bend them sideways with respect to the body member.

A remote manipulation device according to the invention can adjust the length of body member, have the force applied to the motion-copying member felt at the operation member, and adjust directions for rotation and bending easily.

Also, the remote manipulation device according to the invention can adjust the length of body member to a needed length stably.

### INDUSTRIAL APPLICATIONS

A remote manipulation device according to the invention may be used as pincers for grabbing an object and a tool for picking fruits, and it may be used where for handling garbage or a radioactive substance.

1. A length adjustable remote manipulation device comprising:
a body member including a first body with an empty space formed inside and a second body installed movably along the first body while inserted inside the first body such that the length thereof is adjustable;
an manipulation member installed at an end of the first body and including a handle with a movable member supported elastically by spring;
a motion-copying member installed at an end of the second body and including pincers; and
a first cable for having the pincers operated according to movement of the movable member by connecting the movable member and the pincers,
wherein at the first body is installed a first movable pulley device hooked in the first cable movably in a length direction of the first body, in the first body between the first movable pulley device and the handle and in the second body between the first movable pulley device and the pincers are installed guiding rollers for adjusting the path of the first cable, and wherein the first movable pulley device is hooked to the second cable having an end fixed to the first body and the other end fixed to the second body, so as to prevent the first cable from being loosened or tightened than before expansion or contraction according to the expansion or contraction of the body member.

2. The length adjustable remote manipulation device of claim 1, further comprising:
a first bevel gear installed rotatably at the first body about a first rotational axis in a length directional of the first body and supporting the handle;
a second bevel gear disposed at the second body facing the first bevel gear, installed rotatably about a second rotational axis in the length direction of the second body, and supporting the pincers;
a third bevel gear installed at the first body rotatably in place about a third rotational axis an extending line of which crosses with an extending line of the first rotational axis;
a fourth bevel gear installed at the second body rotatably in place about a fourth rotational axis an extending line of which crosses with an extending line of the second rotational axis; and
a power-delivering member for delivering a rotational power of the third bevel gear to the fourth bevel gear.

3. The length adjustable remote manipulation device of claim 2, wherein inside the first body is movably installed a second movable pulley device hooked to the power-delivering member movably in a length direction of the first body, in the first body between the second movable pulley device and the third rotational axis and in the second body between the second movable pulley device and the fourth rotational axis are installed guiding rollers for adjusting path of the power-delivering member, and the second movable pulley device is hooked to a third cable having an end fixed to the first body and the other end fixed to the second body, so as to prevent the power-delivering member from being loosened or tightened than before expansion or contraction according to the expansion or contraction of the body member.

4. The length adjustable remote manipulation device of claim 1, wherein in one of the first body and the second body is installed a rack gear, and in the other one are installed a worm gear engaging the rack gear and a motor for rotating the worm gear.

5. The length adjustable remote manipulation device of claim 2, wherein the third bevel gear comprises a pair of third bevel gears engaging both sides of the first bevel gear respectively so as to rotate oppositely to each other about the third rotational axis if the first bevel gear rotates about the first rotational axis, and wherein the fourth bevel gear comprises a pair of fourth bevel gears engaging both sides of the second bevel gear respectively so as to rotate oppositely to each other about the second rotational axis if the second bevel gear rotates about the second rotational axis.

6. The length adjustable remote manipulation device of claim 2, wherein as rotating the handle about the first rotational axis, the motion-copying member where the pincers are installed is configured to rotate in a direction same as or opposite to the direction of the handle about the second rotational direction.

7. The length adjustable remote manipulation device of claim 2, wherein as rotating the handle about the third rotational axis, the motion-copying member where the pincers are installed is configured to rotate in a direction same as or opposite to the direction of the body member about the fourth rotational direction.
